(19) United States
(12) Patent Application Publication
(10) Pub. No.: US 2015/0147093 A1
(43) Pub. Date: May 28, 2015

(54) DRIVE TRANSMISSION DEVICE AND IMAGE FORMING APPARATUS

(71) Applicant: CANON KABUSHIKI KAISHA, Tokyo (JP)

(72) Inventors: Yuri Mori, Tokyo (JP); Seiji Hara, Tokyo (JP); Tadashi Matsumoto, Tokyo (JP); Kota Kiyama, Kawasaki-shi (JP)

(21) Appl. No.: 14/554,491

(22) Filed: Nov. 26, 2014

(30) Foreign Application Priority Data
Nov. 27, 2013 (JP) 2013-245133

(51) Int. Cl. G03G 15/00; F16H 7/00

(52) U.S. Cl. CPC F16H 55/38; G03G 15/757; F16H 7/02
USPC 399/167; 474/142

(57) ABSTRACT

A drive transmission device includes a first pulley rotationally driven by a driving unit; a second pulley; a belt extended around the first pulley and the second pulley; and a supply unit for supplying a voltage such that the first pulley and the belt are attracted to each other and that the second pulley and the belt are attracted to each other.

### FIELD OF THE INVENTION AND RELATED ART

The present invention relates to driving force transmitting technologies for transmitting the rotational force of a driving force source to an object to be driven, with the use of a belt.

It has been a common practice to provide various apparatuses such as an image forming apparatus with a driving force transmitting apparatus (device) which is for transmitting the rotational force of a driving force source such as a motor.

In the field of an image forming apparatus, for example, a structural arrangement has been employed for transmitting the driving force of a motor as a driving force source, to a driving roller for driving a photosensitive drum and/or an intermediary transfer belt, which are the object to be driven. In the case of this structural arrangement, however, vibrations which are attributable to the errors which occur as driving force is transmitted from a gear (driving force input gear) into which the driving force is inputted, to a gear (driven gear) to which the rotational force is transmitted. Thus, it was possible for the vibrations caused by the gears to travel to shafts, bearings, gear supporting components such as lateral plates, and generate large noises.

There is disclosed in United State Laid-open Patent Application US 2002/0176722, a driving force transmitting apparatus which has a belt having through holes, and a pulley having projections.

In the case of the driving force transmitting apparatus disclosed in United State Laid-open Patent Application US 2002/0176722, it is possible that if the belt is torn and/or stretched, the projections of the pulley will fail to fit into the holes of the belt, and therefore, the driving force will not be transmitted at a high level of precision.

### SUMMARY OF THE INVENTION

According to an aspect of the present invention, there is provided a drive transmission device comprising a first pulley rotationally driven by a driving unit; a second pulley; a belt extended around said first pulley and said second pulley; and a supply unit for supplying a voltage such that said first pulley and said belt are attracted to each other and that said second pulley and said belt are attracted to each other.

Further features of the present invention will become apparent from the following description of exemplary embodiments (with reference to the attached drawings).

### BRIEF DESCRIPTION OF THE DRAWINGS

FIG. 1 is a sectional view of an image forming apparatus.

FIG. 2 is a perspective view of a driving force transmitting apparatus.

FIG. 3 is a sectional view of the driving force transmitting apparatus, at a plane which is perpendicular to the rotational axis of the shaft of each roller and coincides with an A-A in FIG. 2.

FIG. 4A is a sectional view of the driving force transmitting apparatus, at a plane which is perpendicular to the rotational axis of the shaft of each of the rollers and coincides with a line B-B in FIG. 3. FIG. 4B is a drawing of the equivalent circuit of the driving force transmitting apparatus shown in FIG. 4A.

FIG. 5 is a drawing which shows the angle of contact between the belt and pulley.

FIG. 6 is a drawing which shows the relationship between the applied voltage and the amount of transmitted driving force.

FIGS. 7A, 7B and 7C are sectional views of examples of modified version of the driving force transmitting apparatus.

FIG. 8A is a sectional view of one of the modified versions of the driving force transmitting apparatus. FIG. 8B is a drawing of the equivalent circuit of the driving force transmitting apparatus shown in FIG. 8A.

FIG. 9A is a sectional view of the driving force transmitting apparatus in the second embodiment of the present invention. FIG. 9B is a drawing of the equivalent circuit of the driving force transmitting apparatus shown in FIG. 9A.

FIGS. 10A, 10B and 10C are sectional views of examples of modified versions of the driving force transmitting apparatus.

FIG. 11A is a sectional view of one of the modified versions of the driving force transmitting apparatus. FIG. 11B is a drawing of the equivalent circuit of the driving force transmitting apparatus shown in FIG. 11A.

FIGS. 12A, 12B and 12C are perspective views of the modified version of the driving force transmitting apparatus.

FIG. 13 is a perspective view of the driving force transmitting apparatus in the third embodiment of the present invention.

FIG. 14A is a sectional view of the driving force transmitting apparatus shown in FIG. 13, at a plane which is perpendicular to the rotational axis of each roller, and which coincides with a line C-C in FIG. 13. FIG. 14B is a drawing of the equivalent circuit of the driving force transmitting apparatus shown in FIG. 14A.

FIG. 15A is a sectional view of one of the modified versions of the driving force transmitting apparatus. FIG. 15B is a drawing of the equivalent circuit of the driving force transmitting apparatus shown in FIG. 15A.

FIG. 16 is a perspective view of the driving force transmitting apparatus in the fourth embodiment of the present invention.

FIG. 17 is a sectional view of the driving force transmitting apparatus in the fourth embodiment, at a plane which is perpendicular to the rotational axis of each roller, and which coincides with a line D-D in FIG. 16.

FIG. 18 is a sectional view of one of the modified versions of the driving force transmitting apparatus.

FIGS. 19A and 19B are sectional views of the modified versions of the driving force transmitting apparatus.

FIG. 20A is a sectional view of the driving force transmitting apparatus in the fifth embodiment of the present invention. FIG. 20B is a drawing of the equivalent circuit of the driving force transmitting apparatus shown in FIG. 20A.

FIG. 21A is a sectional view of the driving force transmitting apparatus in the sixth embodiment of the present invention. FIG. 21B is a drawing of the equivalent circuit of the driving force transmitting apparatus shown in FIG. 21A.

### DESCRIPTION OF THE PREFERRED EMBODIMENTS

### Embodiment 1

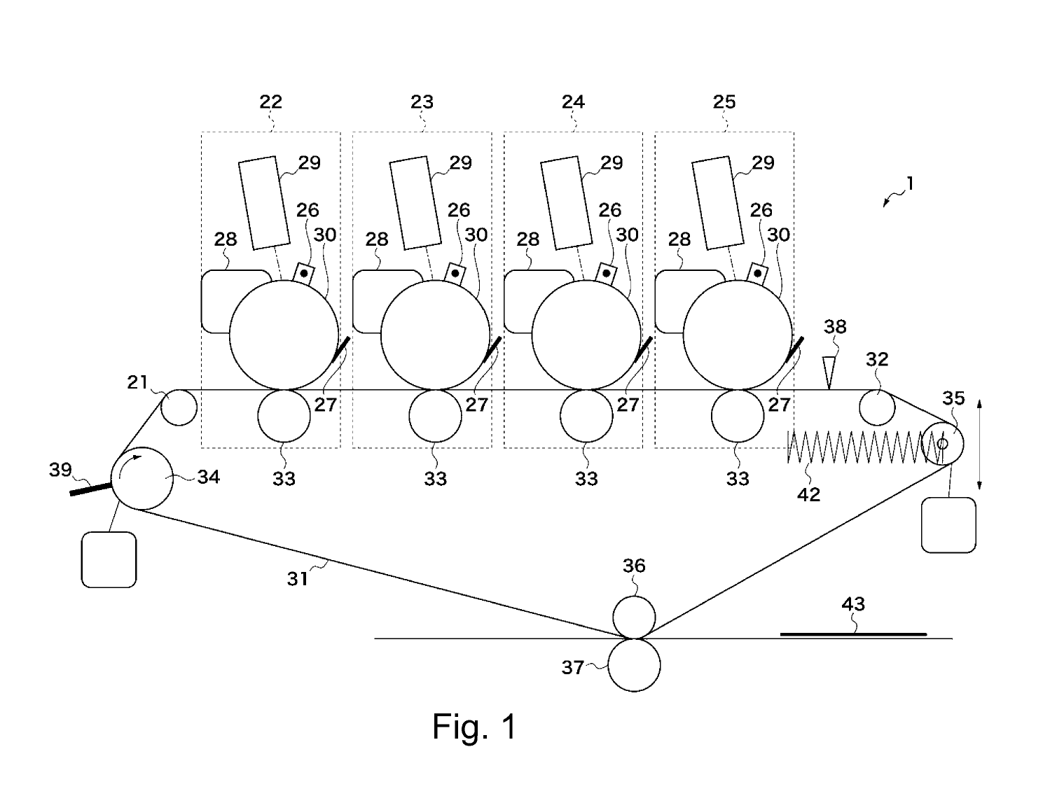

FIG. 1 is a sectional view of the image forming apparatus equipped with the driving force transmitting apparatus in the first embodiment of the present invention. Hereinafter, if a structural element in a given drawing is the same in referential code as a structural element in another drawing, it means that the two elements are the same in structure.

An image forming apparatus 1, which is provided with the driving force transmitting apparatus in this embodiment is an electrophotographic printer. The image forming apparatus 1 carries out an operation for printing an image on a sheet 43 of recording paper, in response to control signals from an unshown control section of the printer.

This image forming apparatus 1 has four image formation sections 22, 23, 24 and 25, which are for forming four images, which are different in color, more specifically, yellow (Y), magenta (M), cyan (C) and black (K) images, respectively. The image formation sections 22-25 are the same in structure in terms of structural element. Thus, the image forming section 22, which is for forming yellow images, is described in detail as the one which represents the four image formation sections. By the way, it is four that is the number of image formation sections employed by the image forming apparatus 1 in this embodiment. However, this embodiment is not intended to limit the present invention in scope in terms of the number of image formation sections. That is, the present invention is also applicable to an image forming apparatus which employs only one image formation section, for example, the image formation station for forming black toner images.

In the image formation section 22, a latent image is formed on the peripheral surface of the photosensitive drum 30, as an image bearing member, which is rotationally driven. More concretely, a primary charging device 26 charges the peripheral surface of the photosensitive drum 30 to a preset potential level to prepare the photosensitive drum 30 for the formation of a latent image. Then, a laser scanner 29 scans the charged peripheral surface of the photosensitive drum 30 with the beam of laser light it outputs while modulating the beam according to image formation data. As a result, an electrostatic latent image which reflects the image formation data is effected upon the charged photosensitive drum 30.

A developing device 28 develops the latent image on the photosensitive drum 30 into a toner image. A primary transfer roller 33 transfers the toner image on the photosensitive drum 30 onto an intermediary transfer belt 31, which is an endless intermediary transferring member, by applying voltage to the intermediary transfer belt 31, from the opposite side of the intermediary transfer belt 31 from the photosensitive drum 30, while pinching the intermediary transfer belt 31 between itself and photosensitive drum 30. A drum cleaning blade 27 scrapes down the toner remaining on the photosensitive drum 30 after the completion of the transfer.

Next, a belt unit is described. The belt unit is made up of the intermediary transfer belt 31, and multiple rollers which rotatably support the intermediary transfer belt 31. These rollers include a driving roller 34, tension rollers 21 and 32, and a steering roller 35. They include also the primary transfer rollers 33 which oppose photosensitive drums 30, one for one. They transfer the toner images formed on the photosensitive drums 30, onto the intermediary transfer belt 31. Further, they include a secondary transfer roller 36 which transfers the toner images transferred onto the intermediary transfer belt 31, onto the sheet 43 of recording paper.

The steering roller 35 is pressed by springs 42 outward of the loop which the intermediary transfer belt 31 forms, from within the loop. It is movably attached. Thus, it provides the intermediary transfer belt 31 with a preset amount of tension. A positional deviation sensor 38 detects the amount of positional deviation of the intermediary transfer belt 31 in terms of the direction perpendicular to the direction in which the intermediary transfer belt 31 conveys a toner image. The angle of the steering roller 35 is controlled based on the detection result of the deviation sensor 38 to compensate for the lateral deviation of the intermediary transfer belt 31.

After the formation of a toner image on the photosensitive drum 30, the toner image is transferred (primary transfer) onto the intermediary transfer belt 31 by the primary transfer roller 33. Image formation processes which are similar to the above-described one are carried out in the image formation sections 23, 24 and 25, one for one. That is, four monochromatic toner images, different in color, are formed on the photosensitive drums 30 one for one, and are transferred in layers onto the intermediary transfer belt 31. Consequently, a full-color toner image is effected on the intermediary transfer belt 31. Then, the intermediary transfer belt 31 conveys the full-color toner image thereon to the area of secondary transfer, in which the toner images are pinched by the secondary transfer top roller 36 and secondary transfer bottom roller 37.

Meanwhile a sheet 43 of recording paper is conveyed from a sheet feeding section to the area of secondary transfer. Then, the full-color toner image on the intermediary transfer belt 31 is transferred onto the sheet 43 by the function of a combination of the secondary transfer top roller 36 and secondary transfer bottom roller 37. The toner which failed to be transferred onto the sheet 43 during the secondary transfer, and therefore, is remaining on the intermediary transfer belt 31 after the secondary transfer, is removed by a cleaning blade 39.

After the transfer of the toner image onto the sheet 43 of recording paper in the area of secondary transfer, the sheet 43 is conveyed to a fixing device (unshown), which is equipped with a fixation roller having a heater, and a pressure roller which presses on the fixation roller. Then, the sheet 43 on which the toner image is present is conveyed through the fixing device by the rotation of the fixation roller and pressure roller while remaining pinched by the two rollers. While the sheet 43 is conveyed through the fixing device, the toner image is fixed to the sheet 43 by the heat from the heater, and the pressure applied by the fixation roller and pressure roller.

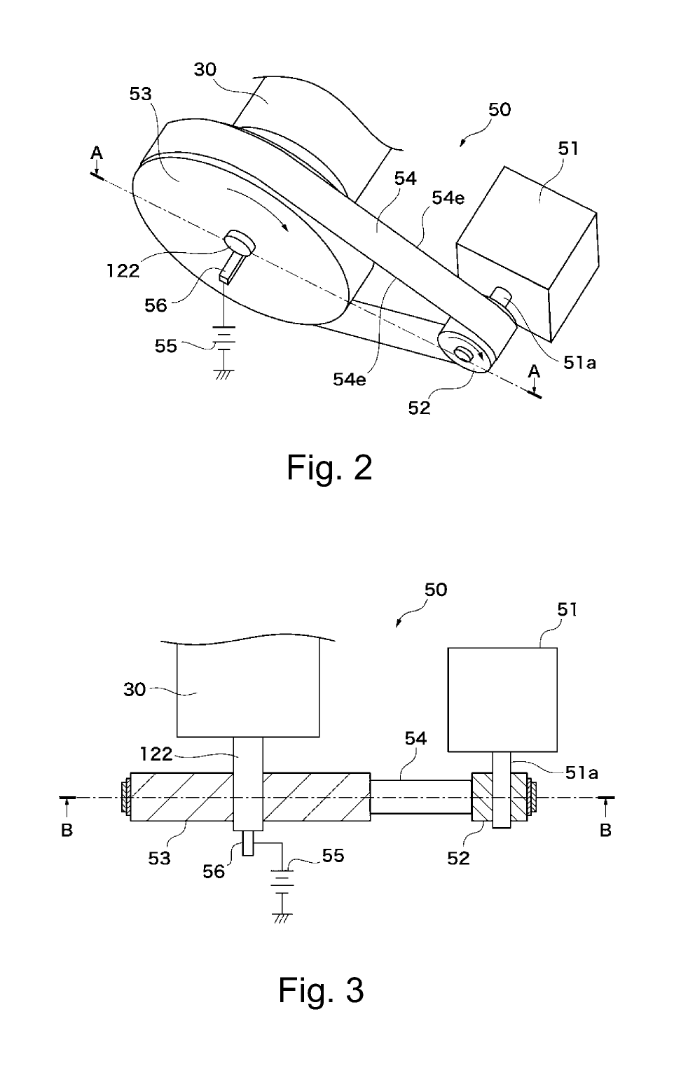

Next, referring to FIGS. 2 and 3, a driving force transmitting device 50 for rotationally driving the drive shaft 122 of the photosensitive drum 30 is described.

In this embodiment, the photosensitive drum 30 is an example of object which is rotationally driven by the rotational driving force transmitted thereto by the driving force transmitting device 50, whereas a motor 51 is an example of source of driving force.

In a case where the driving force transmitting device 50 is employed by the image forming apparatus 1, the example to be driven by the driving force transmitting device 50 may be the driving roller 34, fixation roller, or the like. Further, this embodiment is not intended to limit the present invention in scope in terms of the structural arrangement for transmitting driving force. That is, not only is the present invention applicable to a case where driving force is transmitted from one pulley to one driven pulley, but also, a case where driving force is transmitted from one pulley to two or more driven pulleys.

FIG. 2 is a perspective view of the driving force transmitting device 50 in this embodiment. FIG. 3 is a sectional view of the driving force transmitting device 50 at a plane indicated by a line A-A in FIG. 2, which coincides with the axial line of the output shaft 51a of the motor 51.

The driving force transmitting device 50 is a device for transmitting the rotational force of the motor 51 while reducing it in speed. The driving force transmitting device 50 is equipped with a driving pulley 50, a driven pulley 52, and an endless belt 54. The driving pulley 52 is connected to the output shaft 51a of the motor 51, and is rotationally driven. The driven pulley 53 is connected to the photosensitive drum 30. The photosensitive drum 30 is rotated by the rotation of the driven pulley 53. The belt 54 is suspended by the driving pulley 52 and driven pulley 53, in such a manner that it bridges between the two rollers 52 and 53, so that the driving force is transmitted by the friction between the belt 54 and two pulleys 52 and 53. In this embodiment, the belt 54 is flat in cross-section. However, the belt 54 may be V-shaped in cross-section, and also, may be ribbed, as long as it can transmits driving force between the two pulleys 52 and 53 by the friction between itself and two pulleys 52 and 53.

Next, each of the structural components of the driving force transmitting device 50 is described. To begin with, the driving pulley 52 is cylindrical, and is connected to the output shaft 51a of the motor 51. It is formed of an electrically conductive metallic substance. Further, it is electrically grounded (GND).

As for the driven pulley 53, it is connected to the drive shaft 122 of the photosensitive drum 30. Like the driving pulley 52, the driven pulley 53 is formed of an electrically conductive metallic substance. However, the drive shaft 122 and driven pulley 53 are electrically insulated from each other, because voltage is applied to the driven pulley 53 in order to make the driven pulley 53 and belt 54 to be electrostatically adhered to each other as will be described later. By making the driven pulley 53 and belt 54 to be adhered to each other, it is possible to prevent the driven pulley 53 and belt 54 slip relative to each other.

As for the method for applying voltage to the driven pulley 53, it is done with the use of a voltage application member 56 such as an electrically conductive brush or the like. More concretely, referring to FIGS. 2 and 3, the voltage application member 56 is in connection to a high voltage DC power source 55 which is a voltage providing means (high voltage applying section). It is disposed in the adjacencies of the rotational shaft of the driven pulley 53 to apply voltage to the driven pulley 53 from the high voltage power source 55 through the voltage application section 56.

The photosensitive drum 30, which is described here, is the photosensitive drum for the image formation section 25 for forming a black toner image. As for the transmission of driving force to three other photosensitive drums 30, it is done through three other driving force transmitting mechanism (belts and pulleys other than belt 54 and pulleys 52 and 53). However, this embodiment is not intended to limit the present invention in scope in terms of driving force transmission. For example, the present invention is also applicable to a driving force transmission mechanism structured so that each photosensitive drum 30 is connected to a corresponding driven pulley, and the belt 54 is wrapped around the driven pulley and a corresponding driving pulley.

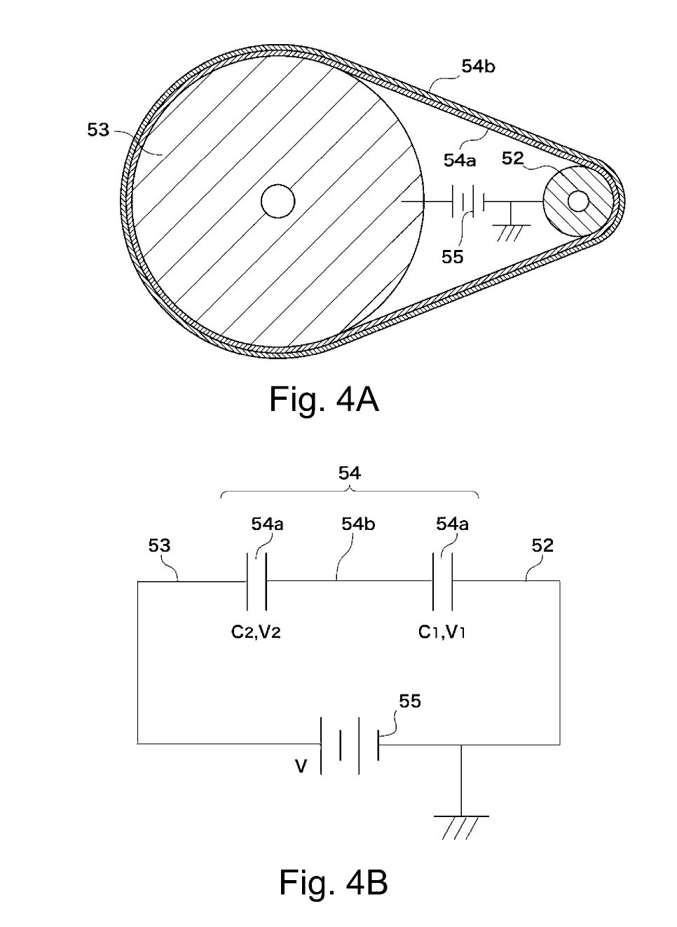

FIG. 4A is a sectional view of the driving force transmitting device 50, at a plane which is perpendicular to the axial line of each of the two rollers, and which coincides with a line B-B in FIG. 3.

Referring to FIG. 4A, the belt 54 has two layers, more specifically, an endless dielectric layer 54a and an endless electrically conductive metallic layer 54b. The dielectric layer 54a is inner layer, that is, the layer which contacts the pulleys 52 and 54. The metallic layer 54b is the outer layer. The material for the dielectric layer 54a is a resinous substance, more specifically, polyamide. However, it does not need to be polyamide. That is, all that is required of the material of the dielectric layer 54a is to be rigid enough to withstand the tension which is generated by the rotational load to which the shaft of the driven pulley 53 is subjected as the driving force is transmitted to the driven pulley 53. The dielectric layer 54a is roughly 70 μm in thickness, and roughly 10 mm in width. However, the thickness of the dielectric layer 54a does not need to be limited to roughly 70 μm. That is, all that is required of the thickness of the dielectric layer 54a is to be sufficient to make the dielectric layer 54a rigid enough to withstand the tension which is generated by the rotational load to which the shaft of the driven pulley 53 is subjected as the driving force is transmitted to the driven pulley 53. As for the metallic layer 54b, it is formed of Ni or the like, by sputtering or the like method. It is roughly 100 nm in thickness.

The belt 54 is not electrically grounded. Voltage is applied to the electrically conductive metallic portion of the driven pulley 53. The electrical conductive metallic portion of the driving pulley 52 is grounded. By the way, a part of the driving pulley 52 and a part of the driven pulley 53 may be electrically nonconductive. In the following description of the embodiments of the present invention, any statement related to electrical connection concerns the electrically conductive portions of the pulleys 52 and 53, that is, the metallic portions of the pulleys 52 and 53, unless specifically noted.

The lateral edges 54e of the belt 54, that is, the edges in terms of the widthwise direction of the belt 54, are electrically insulated to prevent electrical discharge from occurring between the metallic layer, that is, electrically conductive portion, of the driving pulley 52, and also, between the metallic layer 54b and driven pulley 53.

Next, referring to FIG. 4B, the electrical function of the driving force transmitting device 50 is described. FIG. 4B is a drawing of the equivalent circuit of the driving force transmitting device 50 shown in FIG. 4A. Referring to FIG. 4B, this circuit is structured so that the driving pulley 52 is electrically grounded; voltage is applied to the driven pulley 53; and belt 54 is grounded, and also, so that the electrically conductive portion of the driving pulley 52, electrically conductive portion (metallic layer 54b) of the belt 54, and electrically conductive portion of the driven pulley 53 are serially connected.

That is, the capacitive component which is attributable to the portion of the dielectric layer 54a, which is between the driving pulley 52 and belt 54, and the capacitive component which is attributable to the portion of the dielectric layer 54a, which is between the driven pulley 53 and belt 54, are serially connected.

As is evident from this serial circuit, the metallic layer 54b and the peripheral surface of the driving pulley 52 oppose to each other with the presence of the dielectric layer 54a between the two, and so does the metallic layer 54b and the peripheral surface of the driven pulley 53. Thus, the dielectric layer 54a forms a virtual condenser. Therefore, an electric field is generated between the metallic layer 54b and driving pulley 52, and between the metallic layer 54b and driven pulley 53. As a result, the metallic layer 54b (belt 54) is electrically adhered to the driving pulley 52 and driven pulley 53 by the electrostatic force generated by this electric field. The generation of this electrostatic adhesive force increases the vertical drag between the belt 54 and two pulleys 52 and 53, which in turns increases the friction between the belt 54 and two pulleys 52 and 53. Thus, it is possible to prevent the belt 54 and two pulleys 52 and 53 from slipping relative to each other. Therefore, it is possible to increase the amount by which the driving force is transmitted from the pulley 52 to the pulley 53.

Next, the phenomenon that the generation of the electrostatic force increases the amount by which the driving force can be transmitted from the pulley 52 to the pulley 53 is described with the use of mathematical formulas.

First, the electrostatic adhesive force is described. Referring to FIG. 4B, “V, C1 and C2” stand for the voltage of the high voltage DC power source 55, electrostatic capacity between the driving pulley 52 and the metallic layer 54b of the belt 54, and electrostatic capacity between the driven roller 53 and the metallic layer 54b of the belt 54, respectively. Further, “V1 and V2” stand for the difference in potential level between the driving pulley 52 and metallic layer 54b, and difference in potential level between the driven pulley 53 and metallic layer 54b. In this case, the differences V1 and V2 in potential level are expressed in the form of mathematical formulas 1 and 2, respectively, according to the mathematical formula related to the condenser of a serial circuit.

$$\begin{matrix}{V}_{1} = \frac{{C}_{2} V}{{C}_{1} + {C}_{2}} & ( 1 ) \\ {V}_{2} = \frac{{C}_{1} V}{{C}_{1} + {C}_{2}} & ( 2 )\end{matrix}$$

If the dielectric constant and thickness of the dielectric layer 54a of the belt 54 are ∈ and d, respectively, and the electrostatic adhesive force between the driving pulley 52 and metallic layer 54b and the electrostatic adhesive force between the driven pulley 53 and dielectric layer 54a are P1 and P2, respectively, P1 and P2 are expressed in the form of mathematical formulas 3 and 4.

$$\begin{matrix}{P}_{1} = \frac{1}{2} ɛ \frac{1}{{d}^{2}} {V}_{1}^{2} & ( 3 ) \\ {P}_{2} = \frac{1}{2} ɛ \frac{1}{{d}^{2}} {V}_{2}^{2} & ( 4 )\end{matrix}$$

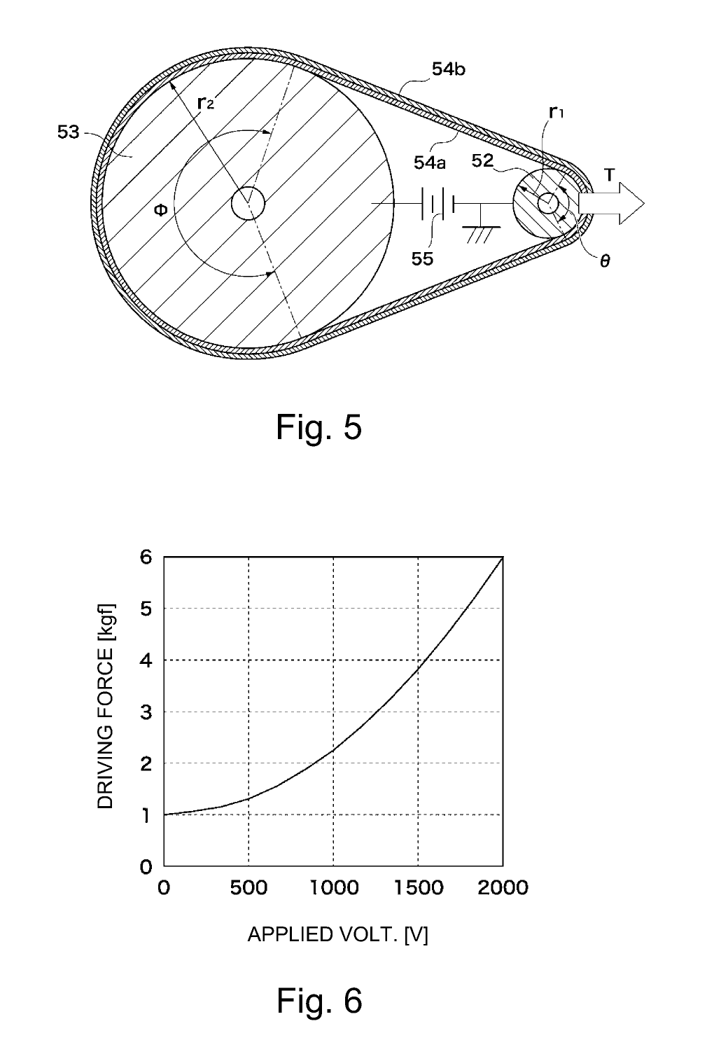

Next, referring to FIG. 5, the amount by which the amount by which the driving force is transmitted is increased by the electrostatic adhesive force is described.

To begin with, let's think about the amount by which the driving force can be transmitted by the driving pulley 52. The amount by which the driving force is transmitted from the driving pulley 52 to the driven pulley 53 through the belt 54 is equivalent to the difference in the effective amount of tension of the driving pulley 52. The amount by which the driving force can be transmitted is expressed in the form of mathematical formula 5, based on Euler's equation, in which “T, θ and μ” stand for the amount of the tension (initial tension) to which the belt 54 is subjected while the belt 54 remains simply wrapped around the driving pulley 52 and driven pulley 53, the angle of contact between the belt 54 and driving pulley 52, and the coefficient of friction between the belt 54 and driving pulley 52, respectively.

$${F}_{1} = \frac{{e}^{μθ} - 1}{{e}^{μθ} + 1} ( \frac{T}{sin \frac{θ}{2}} ) \qquad ( 5 )$$

In comparison, the amount F2 by which the driving force can be transmitted after the friction is increased by the increase in the vertical drag attributable to the addition of the electrostatic adhesive force is expressed in the form of mathematical equation 6, in which “r1 and b” stand for the radius of the driving pulley 52 and the width of the belt 54.

$${F}_{2} = \frac{{e}^{μθ} - 1}{{e}^{μθ} + 1} ( 2 {r}_{1} b {P}_{1} ) \qquad ( 6 )$$

Thus, the sum of the amount (total amount Fk of driving force) by which the driving force can be transmitted by the pulley 52, that is, the amount which is generated by a combination of tension T and electrostatic adhesive force P1 is expressed in the form of mathematical equation 7.

$${F}_{k} = {F}_{1} + {F}_{2} = \frac{{e}^{μθ} - 1}{{e}^{μθ} + 1} ( \frac{T}{sin \frac{θ}{2}} + 2 {r}_{1} b {P}_{1} ) \qquad ( 7 )$$

As is evident from mathematical formulas 7 and 3, the total amount of driving force Fk is linearly proportional to tension T. However, it is also proportional to square of potential difference V1 for generating the electrostatic adhesive force P1. Thus, for the purpose of increasing the amount by which the driving force is transmitted, increasing the electrostatic adhesive force P1 is more effective than increasing the tension T.

FIG. 6 is a drawing for showing the relationship between the applied voltage and the amount by which the driving force is transmitted. This relation is obtained by calculating the total amount Fk by which the driving force is transmitted, with the use of mathematical formula 7. In the drawing, the horizontal axis stands for the applied voltage (measured in volt), and the vertical axis stands for the amount (kgf) by which the driving force is transmitted. It is evident from FIG. 6 that the total amount of driving force transmitted is proportional to square of the applied voltage. For example, in a case where the amount of driving force necessary to properly drive the photosensitive drum 30 is 3 kgf, the amount of necessary voltage is roughly 1,300 V. In other words, the high voltage power source with which any ordinary image forming apparatus is provided is sufficient to provide this level of voltage.

As the sum of driving force which occurs on the driving roller 52 side can be expressed in the form of mathematical formula 7, the sum (total amount F1 of driving force) of the driving force generated on the driven pulley 53 side is expressed in mathematical formula 8, in which “r2, φ and μ” stand for the radius of the driven pulley 53, angle of contact between the belt 54 and driven pulley 53, and coefficient of friction between the belt 54 and driven pulley 53.

$${F}_{j} = \frac{{e}^{μθ} - 1}{{e}^{μθ} + 1} ( \frac{T}{sin \frac{θ}{2}} + 2 {r}_{2} b {P}_{2} ) \qquad ( 8 )$$

By the way, if it is wanted to ensure that the slip does not occur, the value for the voltage to be applied by the high voltage DC power source 55 needs to be set with a certain amount of safety margin. In particular, attention should be paid to the voltage to be applied to the pulley (which in this embodiment is driving pulley 52 which is smaller in angle of contact with belt 54) which is most likely to incur the slip. This is why the total amount Fk of driving force and total amount Fj of driving force are set to be greater than the numerical value obtainable by dividing the amount of rotational load to which the shaft of the driven pulley 53 is subjected, by the radius r2 of the driven pulley 53.

According to this embodiment, the dielectric layer 54a is placed between the metallic layer 54b of the belt 54 and the driving pulley 52, across the area of contact between the belt 54 and driving pulley 52. Further, the dielectric layer 54a is placed between the metallic layer 54b and driven pulley 53, across the area of contact between the belt 54 and driven pulley 53. Moreover, the electrically conductive portion of the driving pulley 52 is made different in potential level from the metallic layer 54b of the belt 54 to cause the former and latter to be electrostatically adhered to each other, and also, the electrically conductive portion of the driven pulley 53 is different in potential level from the metallic layer 54b to cause the former and latter to be electrostatically adhered to each other.

With the use of the above described setup, it is possible to increase the amount of friction between the belt 54 and the two pulleys 52 and 53 to prevent slip from occurring between the belt 54 and two pulleys 52 and 53. The driving force transmitting device 50 which employs the pulleys 52 and 53, and belt 54, is substantially smaller in the amount of vibrations and noises which are likely to occur as driving force is transmitted, than a driving force transmitting mechanism (device) which employs gears. That is, this embodiment makes it possible to provide a gear-less driving force transmitting device which is definitely smaller in the amount of vibrations and noises than a driving force transmitting device which uses gears, and prevents slip from occurring, and therefore, can highly precisely transmit the rotational force of the driving pulley 52 to the driven pulley 53. That is, the present invention which is related to a gear-less driving force transmitting apparatus (device) can ensure that the photosensitive drum 30 is rotationally driven by a gear-less driving force transmitting apparatus (device), with a high level of reliability.

Further, the friction is increased with the use of electrostatic adhesive force. Therefore, the amount of tension T does not need to be set to an excessively large value. Thus, this embodiment can prevent the problem that the components of a driving force transmitting apparatus (device) change in dimension (degree of parallelism between supporting shaft of pulley 52 and supporting shaft of pulley 53, for example) due to prolonged usage. In other words, this embodiment is beneficial from the standpoint of improving a driving force transmitting device in durability.

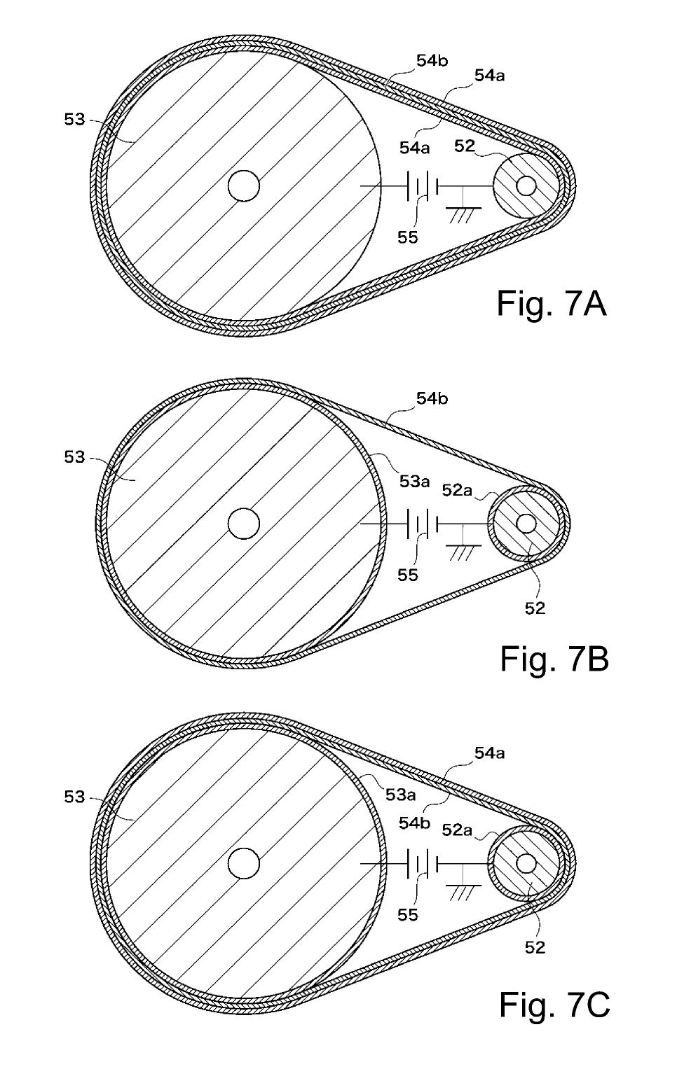

By the way, the belt 54 is made up of two layers, that is, the dielectric layer 54a and metallic layer 54b. However, this embodiment is not intended to limit the present invention in scope in terms of belt structure. That is, all that is required of a given driving force transmitting device (50) to be compatible with the present invention is for the device to have a serial circuit which is similar to the one shown in FIG. 4B. In order to realize such a circuit, there has to be a dielectric layer (which hereafter may be referred to as first dielectric layer) between the electrically conductive metallic layer 54b of the belt 54 and the electrically conductive portion of the driving pulley 52, across the area of contact between the belt 54 and driving pulley 52. Also, there has to be a dielectric layer (which hereafter may be referred to as second dielectric layer) between the electrically conductive metallic layer 54b of the belt 54 and the electrically conductive portion of the driven pulley 53, across the area of contact between the belt 54 and driven pulley 53. All that is required of the first dielectric layer is that at least one of the belt 54 and driving pulley 52 is provided with the first dielectric layer. Further, all that is required of the first second dielectric layer is that at least one of the belt 54 and driven pulley 53 is provided with the second dielectric layer. Shown in FIG. 7 are modified version of the driving force transmitting device 50 in the first embodiment, including the above described version.

The belt 54 may be structured in three layers by adding (laying) another dielectric layer 54a to (upon) the outward surface of the belt 54 structured as shown in FIG. 4A. In this case, the dielectric layer 54a function as the first and second dielectric layers as in the case of the belt 54 shown in FIG. 4A.

Or, a driving force transmitting device 50 may be structured so that the pulley 52 is provided with a dielectric layer 52a, which is placed on the outward surface of the driving pulley 52; the driven pulley 53 is provided with a dielectric layer 53a, which is placed on the peripheral surface the driven pulley 53; the belt 54 has only a metallic layer 54b formed of stainless steel or the like. In this case, the thickness of the metallic layer 54b is roughly 70 μm.

In this case, the dielectric layer 52a functions as the first dielectric layer, and the dielectric layer 53a functions as the second dielectric layer. In the case of the equivalent circuit for this modification, the portion of dielectric layer 54a, which is between the driving pulley 52 and metallic layer 54b, shown in FIG. 4B, is replaced by the dielectric layer 52a, the portion of dielectric layer 54a, which is between the metallic layer 54b and driven pulley 53, shown in FIG. 4B, is replaced by the dielectric layer 53a.

By the way, referring to FIG. 7C, a dielectric layer 54a may be formed on the outward surface of the metallic layer 54b of the belt 54 structured as shown in FIG. 7B.

Although the following modification is not illustrated, the belt 54 of the driving force transmitting device 50 structured as shown in FIG. 7B may be replaced with a two-layer belt having a dielectric layer 54a on the inward surface of its metallic layer 54b. In this case, both the thickness of the combination of the dielectric layer 52a and dielectric layer 54a, and the thickness of the combination of the dielectric layer 53a and dielectric layer 54a, are made to be roughly the same as the thickness of the dielectric layer 54a shown in FIG. 4A. Also in this case, the portion of the dielectric layer 52a, and the portion of the dielectric layer 54a, which overlap with each other, function together as the first dielectric layer, and the portion of the dielectric layer 53a, and the portion of the dielectric layer 54a, which overlap with each other, function together as the second dielectric layer.

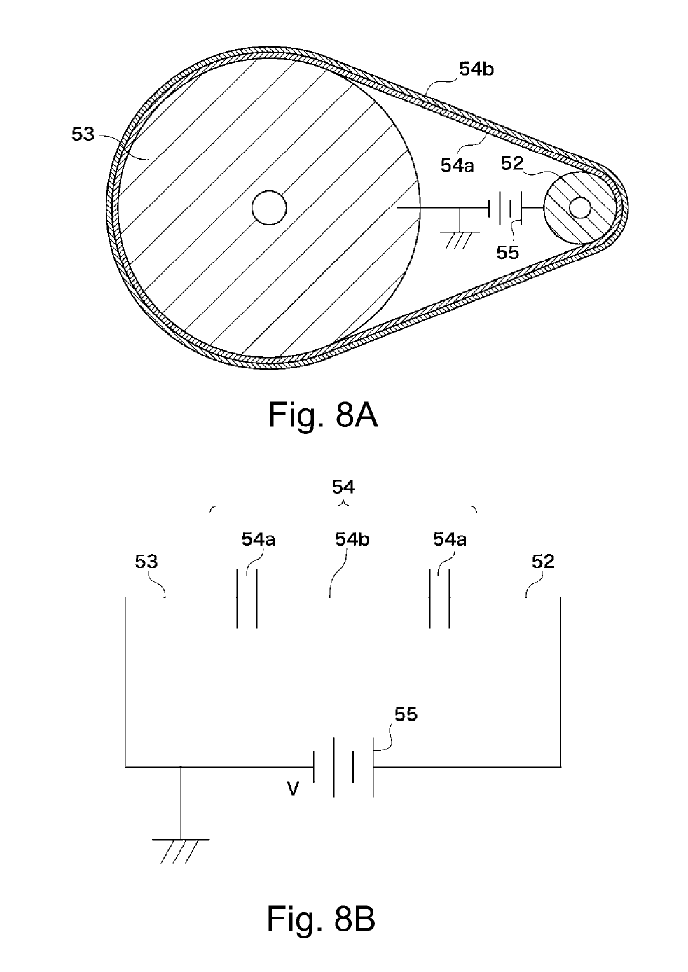

By the way, in this embodiment, voltage is applied to the driven pulley 53 to generate electrostatic adhesive force, and driving pulley 52 is electrically grounded. However, this embodiment is not intended to limit the present invention in scope. That is, this embodiment can be modifiable as shown in FIGS. 8A and 8B. In these cases, voltage is applied to the driving pulley 52, whereas the driven pulley 53 is electrically grounded, as shown in FIGS. 8A and 8B. In a case where voltage is applied to the driving pulley 52 as described above, it is necessary to electrically insulate between the output shaft 51a and driving pulley 52.

According to this embodiment, the driving pulley 52 and belt 54 are electrostatically adhered to each other by the high voltage DC power source 55, and also, the driven pulley 53 and belt 54 are electrostatically adhered to each other by the high voltage DC power source 55. Therefore, it is possible to reduce the vibrations and noises attributable to the driving of the motor 51, and also, to highly precisely transmit the rotational force of the motor 51 to the photosensitive drum 30.

Further, according to this embodiment, the driving pulley 52 and belt 54 are electrostatically adhered to each other by the high voltage DC power source 55, and also, the driven pulley 53 and belt 54 are electrostatically adhered to each other by the high voltage DC power source 55. Therefore, it is possible to prevent the occurrence of the sound (slip noise) attributable to the slip which occurs between the driven pulley 53 and belt 54.

### Embodiment 2

The image forming apparatus 1 in the second embodiment of the present invention is different from the image forming apparatus 1 in the first embodiment, in the structural arrangement for generating the electrostatic adhesive force. Otherwise, the two image forming apparatuses are the same in structure.

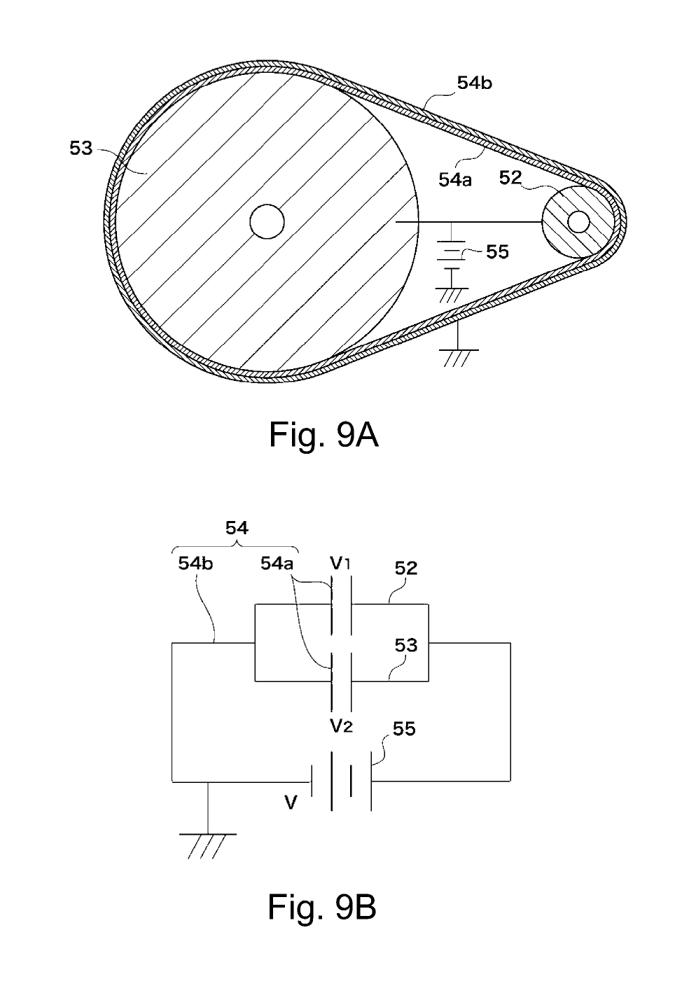

FIG. 9A is a sectional view of the driving force transmitting device 50 in this embodiment. FIG. 9B is a drawing of the equivalent circuit of the driving force transmitting device 50 shown in FIG. 9A.

Referring to FIG. 4A, in the first embodiment, the electrically conductive portion of the driving pulley 52, dielectric layer 54a of the belt 54, and electrically conductive portion of the driven pulley 53 are serially connected. In comparison, in the second embodiment, the electrically conductive portion of the driving pulley 52, and the electrically conductive portion of the driven pulley 53, are electrically connected in parallel.

The driving pulley 52 and driven pulley 53 are made equal in potential level with the use of the high voltage DC power source 55, as shown in FIG. 9A. As for the means for supplying each of the pulleys 52 and 53 with voltage, an electrically conductive brush or the like is placed in contact with roughly the center of each of the pulleys 52 and 53. The belt 54 is structured in two layers like the belt 54 in the first embodiment. Thus, the dielectric layer 54a of the belt 54 contacts each of the pulleys 52 and 53, whereas the metallic layer 54b is grounded, with the use of an electrically conductive brush, a roller, or the like, which is placed in contact with the metallic layer 54b and grounded.

Referring to FIG. 9B, the peripheral surface of each of the two pulleys 52 and 53 opposes the metallic layer 54b of the belt 54, with the presence of the dielectric layer 54a of the belt 54 between itself and metallic layer 54b. Thus, the portion of the dielectric layer 54a, which is in the area in which the pulley 52 opposes the metallic layer 54b, and the portion of the dielectric layer 54a, which is in the area in which the pulley 53 opposes the metallic layer 54b, form a virtual condenser.

That is, the capacitive component of the portion of the dielectric layer 54a which is between the driving pulley 52 and the metallic layer 54b of the belt 54, and the capacitive component of the portion of the dielectric layer 54a which is between the driven pulley 53 and the metallic layer 54b of the belt 54, are connected in parallel.

Thus, an electric field is generated between the metallic layer 54b and the electrically conductive portion of each of the driving pulley 52 and driven pulley 53. Therefore, the driving pulley 52 and belt 54 are electrically adhered to each other by the electrostatic force generated by the electric field, and so are the driven pulley 53 and belt 54. In terms of the effect that electrostatic adhesive force is generated between the driven pulley 53 and belt 54 to increase the friction between the driven pulley 53 and belt 54, the second embodiment is the same as the first embodiment.

The phenomenon that the amount by which the driving force is transmitted is increased by the generation of the electrostatic adhesive force, in this embodiment, is described with the use of a mathematical formula.

First, the electrostatic adhesive force is described. Referring to FIG. 9B, this equivalent circuit is a parallel circuit. Then, as the voltage of the high voltage DC power source 55 is set to V, the difference V1 in potential level between the driving pulley 52 and the metallic layer 54b of the belt 54, and the difference V2 in potential level between the driven pulley 53 and the metallic layer 54b of the belt 54, become the same in value (V=V1=V2).

In terms of the amount of electrostatic adhesive force per unit area, the electrostatic adhesive force P1 between the driving pulley 52 and metallic layer 54b, and the amount of the electrostatic adhesive force P2 between the driven pulley 53 and metallic layer 54b, become the same in value. These electrostatic adhesive forces P1 and P2 are expressible in the form of mathematical formula 9.

$${P}_{1} = {P}_{2} = \frac{1}{2} ɛ \frac{1}{{d}^{2}} {V}^{2} \qquad ( 9 )$$

The amount by which the driving force can be transmitted by the driving force transmitting device 50 in this embodiment while being assisted by the electrostatic adhesive force is the same as that in the first embodiment described above. The total amount Fk of driving force which can be transmitted by the pulley 52, and the total amount Fj of driving force which can be transmitted by the pulley 53, can be obtained by substituting P1 and P2 in mathematical formulas 7 and 8 with the values obtainable with the use of mathematical formula in mathematical formulas 7 and 8. From the standpoint of setting the voltage to be applied to the high voltage DC power source 55 in consideration of the margin for safety in order to set the total amounts Fk and Fj of driving force to prevent the occurrence of the slip, this embodiment is the same as the first embodiment.

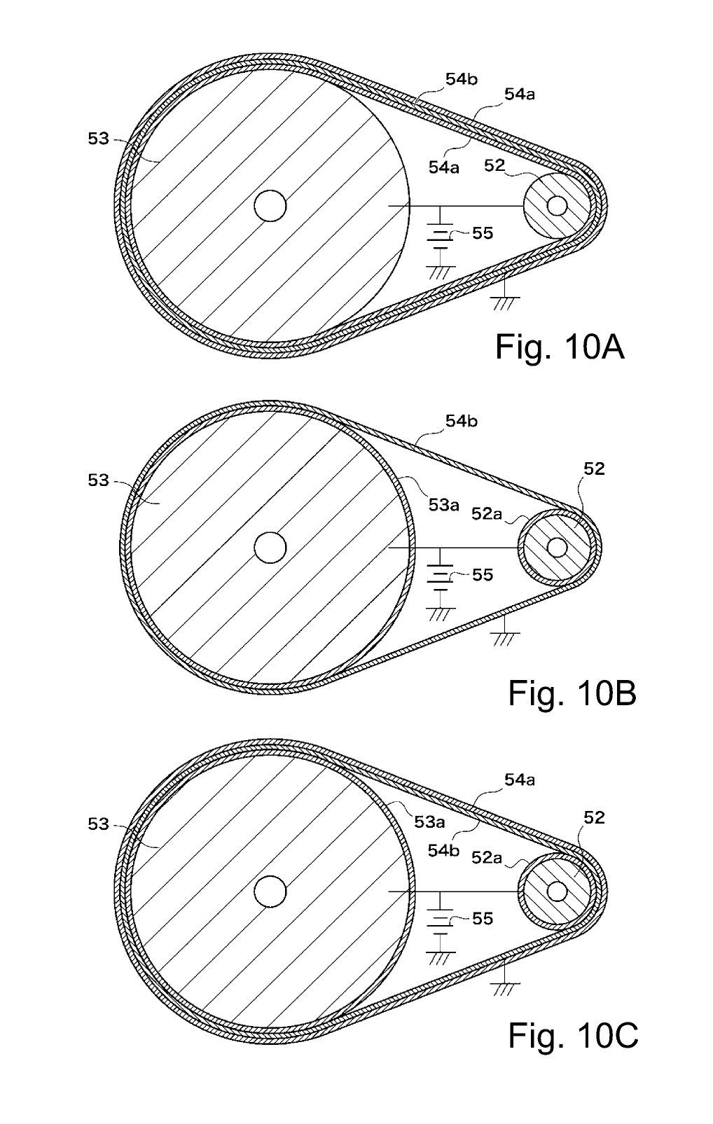

By the way, also in this embodiment, the belt 54 does not need to be two-layered. That is all that is required of the belt 54 is that the belt 54 is provided with the first dielectric layer 54a positioned so that it will be between the metallic layer 54b of the belt 54 and the conductive portion of the driving pulley 52, and the second dielectric layer 54a which will be between the metallic layer 54b of the belt 54 and the driven pulley 53. Thus, the driving force transmitting devices 50 in this embodiment can be modified, as shown in FIGS. 10A-10C, as the driving force transmitting device 50 in the first embodiment can be modified as shown in FIGS. 7A-7C.

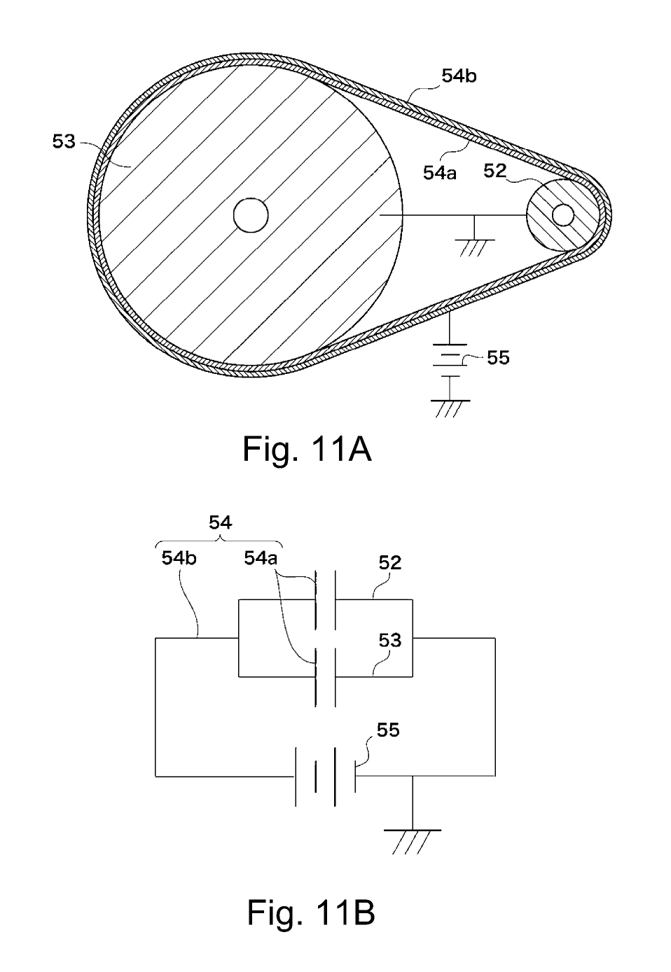

Shown in FIGS. 11A and 11B is another modification of this embodiment. In the case of the driving force transmitting device 50 shown in FIGS. 11A and 11B, the high voltage DC power source 55 applies voltage to the belt 54, and the driven pulley 53 and driving pulley 52 are electrically grounded.

The driving pulley 52 and driven pulley 53 may be grounded through their support shafts, or a pair of electrically conducive brushes which are grounded and placed in contact with roughly the centers of the pulleys 52 and 53, one for one. As for the means for supplying the metallic layer 54b of the belt 54 with electric power, it may be an electrically conductive brush, roller, or the like, which is placed in contact with the metallic layer 54b. In terms of the calculation of the amount of electrostatic adhesive forces P1 and P2, calculation of the total amounts Fk and Fj of driving force, and setting of the voltage to be applied by the high voltage DC power source 55, in consideration of safety margin, this modification is the same as those shown in FIG. 9.

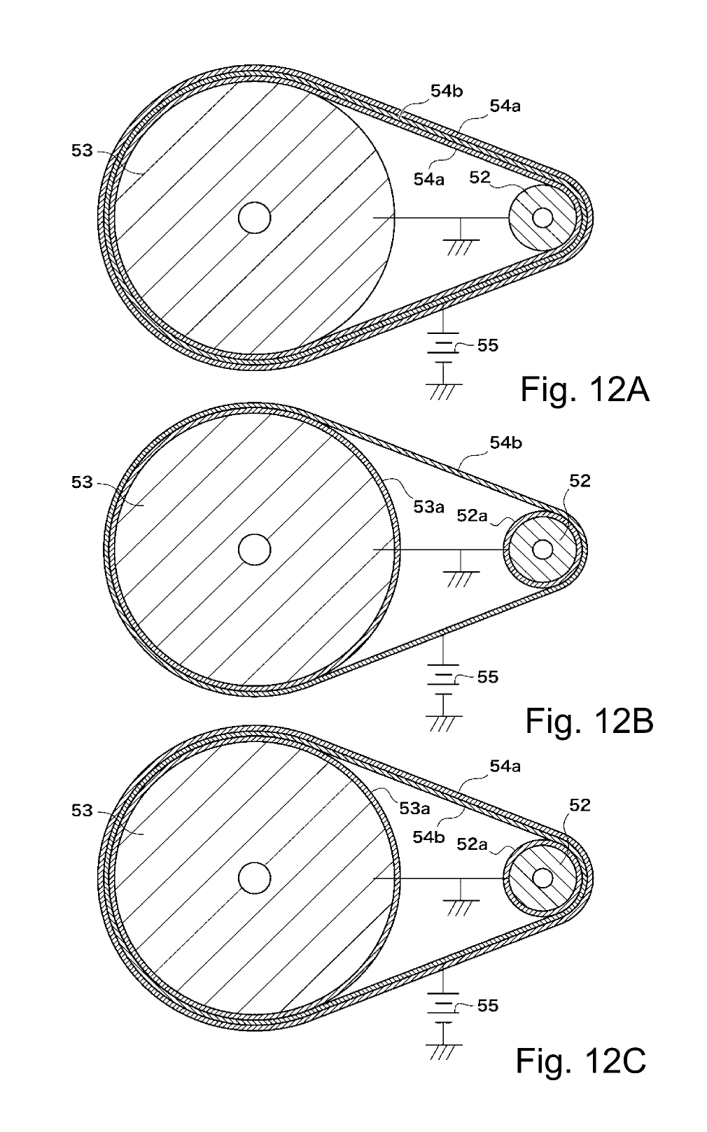

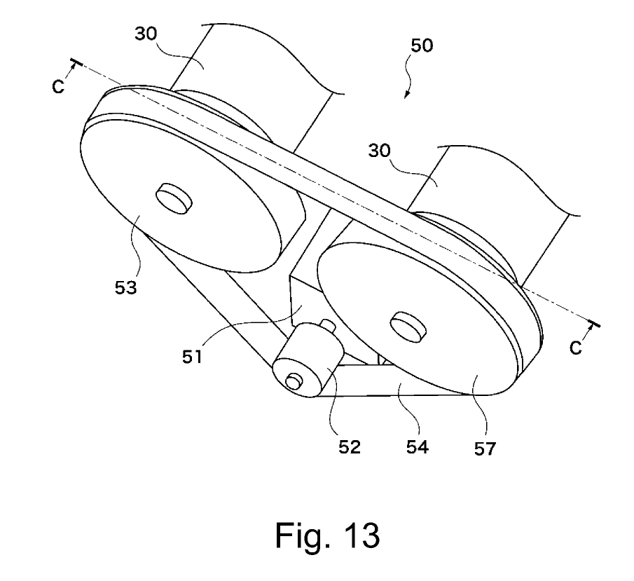

Further, even though this modification of the driving force transmitting device 50 is structured so that the high voltage DC power source 55 applies voltage to the belt 54, the belt does not need to be two-layered. All that is required of the belt 54 is that the belt 54 is provided with the first dielectric layer which will be between the metallic layer 54b of the belt 54 and the electrically conductive portion of the driving pulley 52, and the second dielectric layer which will be between the metallic layer 54b and driven pulley 53. Therefore, this embodiment can be modified as shown in FIGS. 12A-12C, as it can be as shown in FIGS. 10A-10C.

According to this embodiment, the driving pulley 52 and belt 54 are electrostatically adhered to each other by the high voltage DC power source 55, and also, the driven pulley 53 and belt 54 are electrostatically adhered to each other by the high voltage DC power source 55. Therefore, it is possible to reduce the vibrations and noises attributable to the driving of the motor 51, and also, to highly precisely transmit the rotational force of the motor 51 to the photosensitive drum 30.

Also according to this embodiment, the driving pulley 52 and belt 54 are electrostatically adhered to each other by the high voltage DC power source 55, and also, the driven pulley 53 and belt 54 are electrostatically adhered to each other by the high voltage DC power source 55. Therefore, it is possible to prevent the occurrence of the sound (slip noise) attributable to the slip which occurs between the driven pulley 53 and belt 54.

### Embodiment 3

In the first and second embodiments, the number of the driven pulley 53 to which the rotation of the driving pulley 52 is transmitted through the belt 54 was only one. In comparison, in this embodiment, there are multiple (two, for example) driven pulleys 53.

FIG. 13 is a perspective view of the driving force transmitting device 50 in the third embodiment.

Referring to FIG. 13, the belt 54 is suspended by the driving pulley 52, driven pulley 53, and driven pulley 57 in such a manner that it bridges between the adjacent two pulleys. The structure of the driven pulley 57 is the same as that of the driven pulley 53. The rotation of the driving pulley 52 which is rotationally driven by the motor 51 is transmitted to the driven pulleys 53 and 57 through the belt 54 to rotate the two photosensitive drums 30, one for one. Incidentally, the number of the driven pulleys may be three or more.

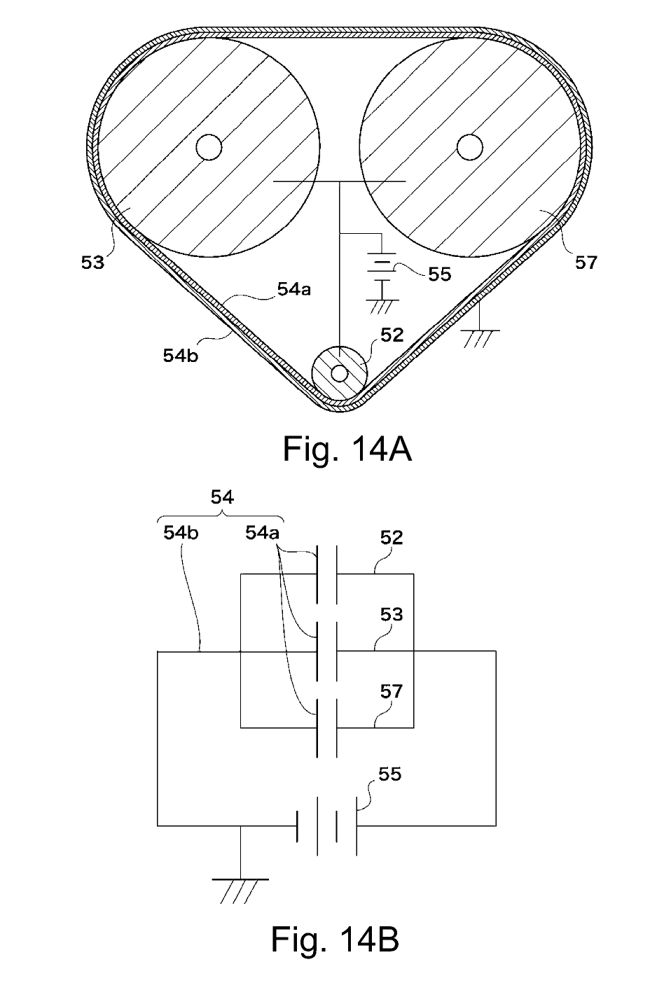

FIG. 14A is a sectional view of the driving force transmitting device 50 shown in FIG. 13, at a plane which is perpendicular to the rotational axis of each roller and coincides with a line C-C in FIG. 13. FIG. 14B is a drawing of the equivalent circuit of the driving force transmitting device 50 shown in FIG. 14A.

The belt 54, driving pulley 52, and driven pulleys 53 and 57 are the same in basic structure as the belt 54, driving pulley 52, and driven pulley 53, respectively, in the second embodiment (FIG. 9).

Referring to FIG. 14A, voltage is applied to the electrically conductive portion of the driving pulley 52, electrically conductive portion of the driven pulley 53, and electrically conductive portion of the driven pulley 57 with the use of the high voltage DC power source 55, whereas the metallic layer 54b of the belt 54 is grounded. Thus, the dielectric layer 54a forms virtual condensers in three areas, one for one, in which the peripheral surfaces of the pulleys 52, 53 and 57 oppose the dielectric layer 54a, as shown in FIG. 14B. Therefore, electrostatic adhesive force occurs, and increases the friction between three pulleys 52, 53 and 57 and the belt 54, which in turn prevents the slip between the pulleys 52, 53 and 57 and belt 54. Also in this embodiment, the voltage to be applied by the high voltage DC power source 55 has to be set so that slip does not occur between the belt 54, and the driving pulley 52 which is smaller in the angle of contact with the belt 54 than other two pulleys 53 and 57.

In the case of this embodiment, the portion of the dielectric layer 54a, which is between the driving pulley 52 and metallic layer 54b functions as the first dielectric layer, and the portions of the dielectric layer 54a, which are between the driven pulleys 53 and 57 and the metallic layer 54b, function as the second dielectric layers.

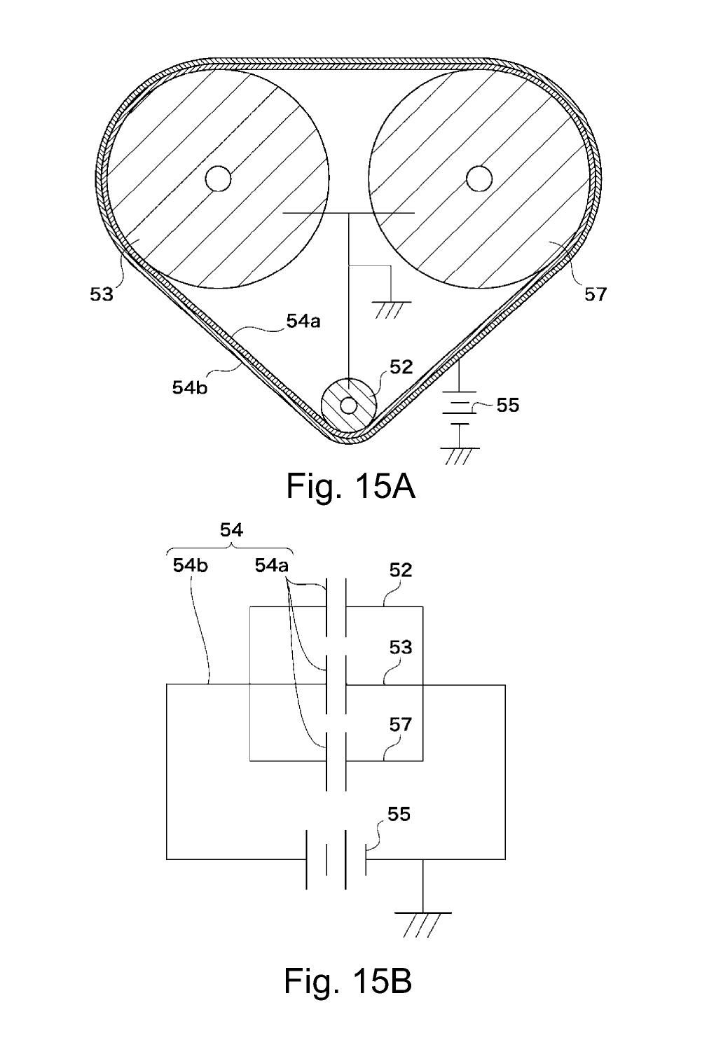

FIGS. 15A and 15B show one of modified versions of the driving force transmitting device 50 in this embodiment. In the case of the driving force transmitting device 50 shown in FIGS. 15A and 15B, the high voltage DC power source 55 applies voltage to the belt 54, whereas the driven pulleys 53 and 57, and driving pulley 52 are electrically grounded.

By the way, the driving force transmitting device 50 in this embodiment, which is structured as shown in FIGS. 14 and 15, can also be modified as shown in FIG. 10, like the driving force transmitting device 50 in the second embodiment.

According to this embodiment, the driving pulley 52 and belt 54 are electrostatically adhered to each other by the high voltage DC power source 55, and so are the driven pulley 53 and belt 54, and the driven pulley 57 and belt 54. Therefore, it is possible to reduce the vibrations and noises attributable to the driving of the motor 51, and also, to highly precisely transmit the rotational force of the motor 51 to the photosensitive drum 30.

Also according to this embodiment, the driving pulley 52 and belt 54 are electrostatically adhered to each other by the high voltage DC power source 55, and so are the driven pulley 53 and belt 54, and the driven pulley 57 and belt 54. Therefore, it is possible to prevent the occurrence of the slip noises attributable to the slip between the driving pulley 52 and belt 54, slip between the driven pulley 53 and belt 54, and slip between the pulley 57 and belt 54.

Moreover, according to this embodiment, the voltage to be applied by the high voltage DC power source 55 is set to prevent the pulley which is the smallest in the angle of contact with the belt 54, or shortest in the area of contact with the belt 54, from slipping. Therefore, the driving force of the driving power source can be highly precisely transmitted to the driven pulleys 53 and 57.

### Embodiment 4

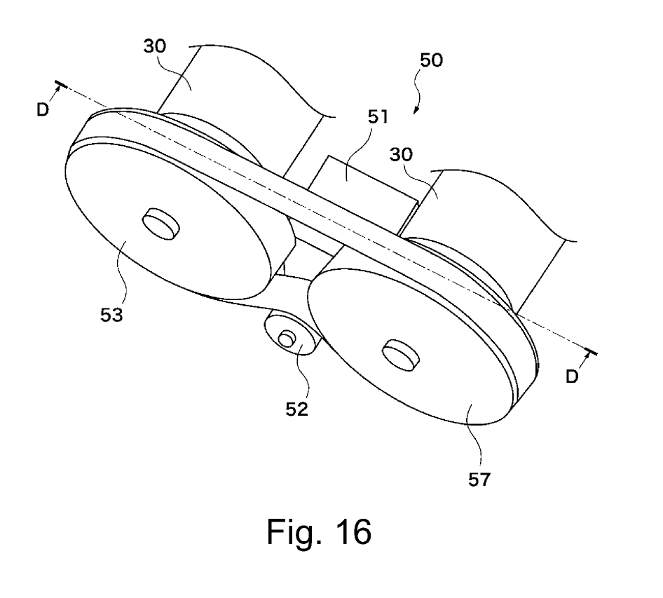

In each of the first to third embodiments, the driving force transmitting device 50 is structured so that all the pulleys were on the inward side of the loop which the belt 54 forms. However, one (or more) of the pulleys may be disposed outside the loop which the belt 54 forms, as shown in FIGS. 16-19.

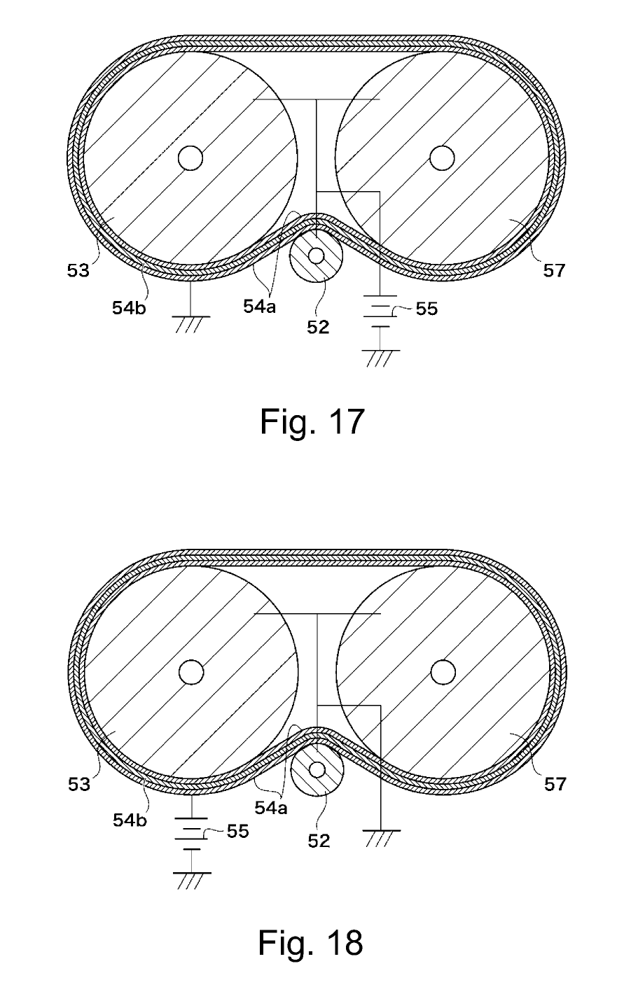

FIG. 16 is a perspective view of the driving force transmitting device 50 in the fourth embodiment. FIG. 17 is a sectional view of the driving force transmitting device 50 in this embodiment, at a plane which is perpendicular to the lengthwise direction of the rotational axes of the pulleys and coincides with a line D-D in FIG. 16.

The fourth embodiment is different from the third embodiment in that the driving pulley 52 is disposed on the outward side of the loop which the belt 54 forms, and also, that the dielectric layer 54a is placed not only on the inward surface of the belt 54, but also, on the outward side of the belt 54. Otherwise, the fourth embodiment is the same in the structure of the driving force transmitting device 50 as the third embodiment.

More concretely, voltage is applied to the electrically conductive portion of each of the driving pulley 52, driven pulley 53, and driven pulley 57, with the use of the high voltage DC power source 55, whereas the metallic layer 54b of the belt 54 is grounded. The equivalent circuit of the driving force transmitting device 50 shown in FIG. 17 is the same as the equivalent circuit shown in FIG. 14B. In the case of this structural arrangement, the portion of the outside dielectric layer 54a, which is between the driving pulley 52 and metallic layer 54b, functions as the first dielectric layer, whereas the portion of the inside dielectric layer 54a, which is between the metallic layer 54b of the belt and the driven pulley 53, and the portion of the dielectric layer 54a, which is between the metallic layer 54b of the belt 54 and the driven pulley 57, function as the second dielectric layers.

In this embodiment, in order to generate the electrostatic adhesive force, voltage is applied to the driven pulley 53, driven pulley 57, and driving pulley 52, whereas the belt 54 is grounded. However, this embodiment is not intended to limit the present invention is scope. That is, the driving force transmitting device 50 in this embodiment may be modified as shown in FIG. 18. That is, it may be modified so that voltage is applied to the belt 54, whereas the driven pulley 53, driven pulley 57, and driving pulley 52 are grounded, as shown in FIG. 18. The equivalent circuit of the driving force transmitting device 50 shown in FIG. 18 is the same as the equivalent circuit shown in FIG. 15B.

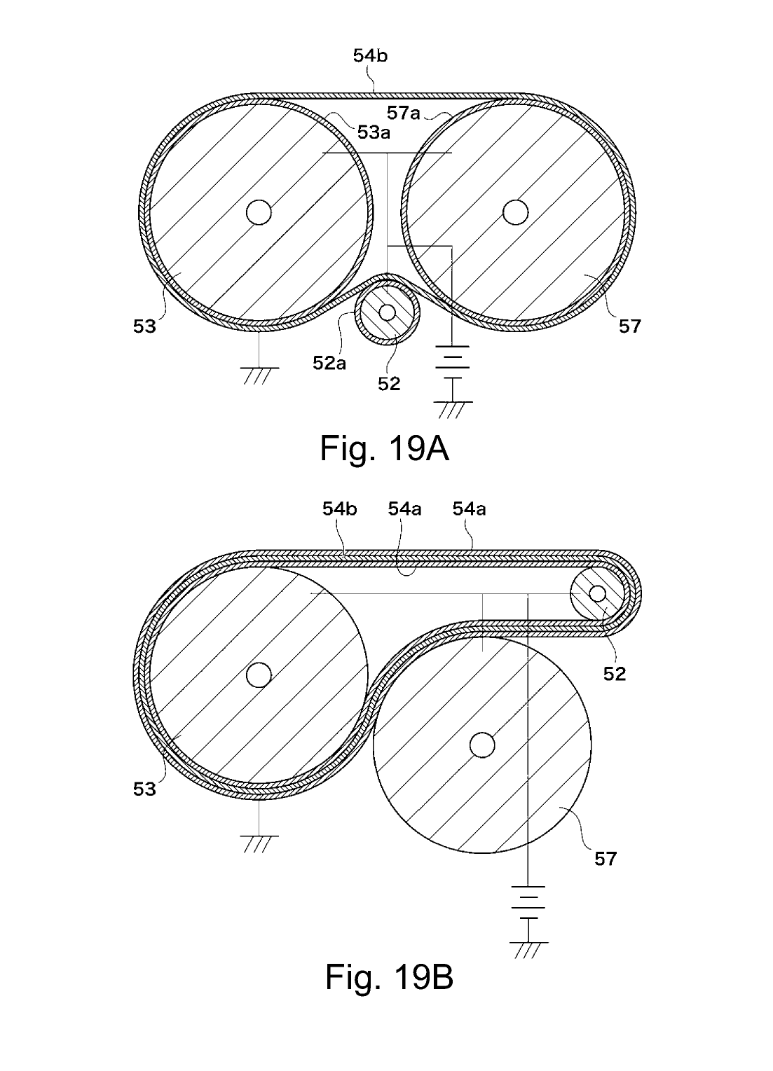

In the case of each of the modified versions of the driving force transmitting device 50 in this embodiment, the dielectric layer 54a is placed not only on the inward surface of the metallic layer 54b of the belt 54, but also, on the outward surface of the metallic layer 54b of the belt 54. However, it may be each of the pulleys, instead of the belt 54, that is provided with the dielectric layer 54a, like the modified version of this embodiment, as shown in FIG. 19A.

That is, referring to FIG. 19A, the dielectric layer 54a is placed on the peripheral surface of the driving pulley 52, and dielectric layers 53a and 57a are placed on the peripheral surfaces of the driven pulleys 53 and 57, respectively. Further, the belt 54 is made to be a single-layer belt, that is, a belt made of only the metallic layer 54b formed of stainless steel or the like. In this case, the dielectric layer 52a functions as the first dielectric layer, and the dielectric layers 53a and 57a function as the second dielectric layers. Moreover, the driving force transmitting device 50 in this embodiment may also be modified, as shown in FIG. 18, so that voltage is applied to the belt 54, whereas the driven pulley 53, driven pulley 57, and driving pulley 52 are electrically grounded.

By the way, in a case where a driving force transmitting device is provided with two or more driven pulleys like the driving force transmitting device 50 in the third embodiment, the device may be structured so that some driven pulleys are disposed on the inward side of the belt loop, whereas the others are disposed on the outward side of the belt loop. Moreover, it may be structured so that the driving pulley is disposed on the inward side of the belt loop, whereas the driven pulleys are disposed on the outward side the belt loop.

For example, referring to FIG. 19B which shows one of the modified versions of the driving force transmitting device 50 in this embodiment, the driving pulley 52 and driven pulley 53 are disposed on the inward side of the belt loop, whereas the driven pulley 57 is disposed on the outward side of the belt 54. Further, the dielectric layer 54a is placed on the inward and outward surfaces of the metallic layer 54b of the belt 54. In this case, the inward dielectric layer 54a functions as the first and second dielectric layers, whereas the outward dielectric layer 54a functions as the second dielectric layer 54.

By the way, in the case of each of the driving force transmitting devices 50 structured as shown in FIGS. 16-19, when the voltage to be applied by the high voltage DC power source 55 is set, special attention should be paid to the pulley which is most likely to slip relative to the belt if no electrostatic adhesive force is present, that is, the pulley (driving pulley 52 or driven pulley 57) which is smallest in the angle of contact with the belt 54, or shortest in the area of contact with the belt, as described above.

### Embodiment 5

In the third and fourth embodiments, the electrically conductive portion of the driving pulley 52, and the electrically conductive portion of the driven pulley 53, are electrically connected in parallel. However, the third and fourth embodiments are not intended to limit the present invention in scope. That is, the electrical connection among the electrically conductive portions of the driving pulley 52 and driven pulley 53 may be parallel connection, serial connection, or mixture of parallel and serial connections.

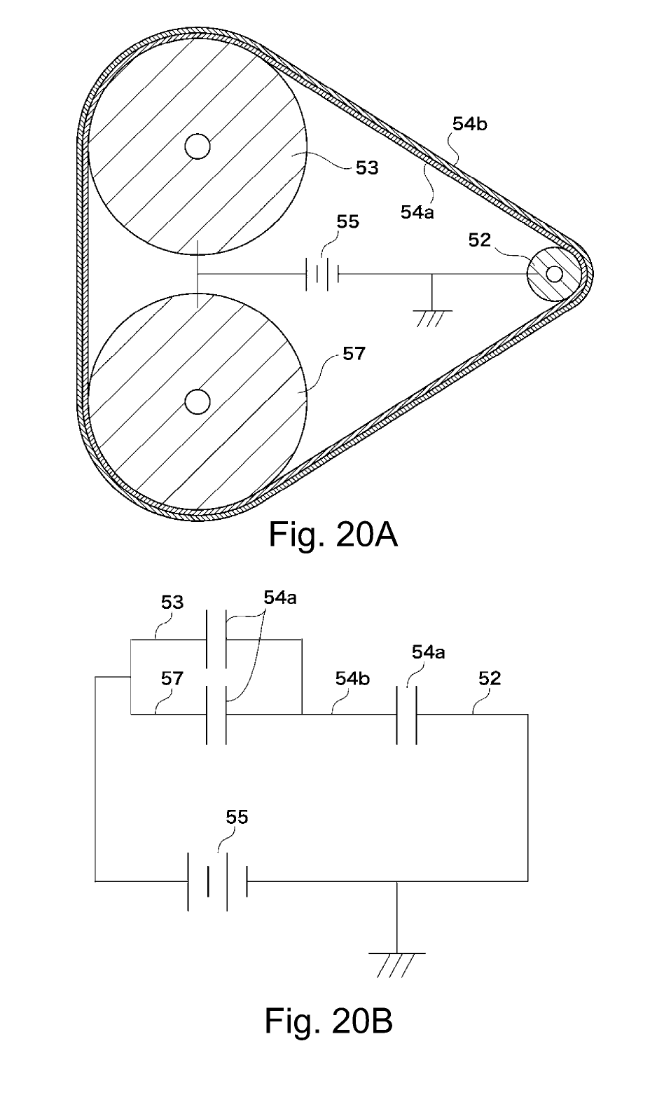

FIG. 20A is a sectional view of the driving force transmitting device 50 in the fifth embodiment. FIG. 20B is an equivalent circuit of the driving force transmitting device 50 shown in FIG. 20A.

The driving pulley 52, driven pulley 53, and driven pulley 57 are disposed on the inward side of the belt loop. The dielectric layer 54a is placed on the inward surface of the metallic layer 54b of the belt 54. Referring to FIG. 20A, the driving pulley 52 is electrically grounded. To the driven pulleys 53 and 57, voltage is applied from the high voltage DC power source 55 to make the two driven pulleys 53 and 57 the same in potential level. The belt 54 is grounded. Thus, the electrically conductive portion of the driven pulley 53, and the electrically conductive portion of the driven pulley 53 are electrically connected in parallel, whereas the electrically conductive portion of the driving pulley 52 is serially connected to the parallelly connected combination of the driven pulleys 54 and 57.

### Embodiment 6

In each of the preceding embodiments, a single high voltage DC power source (55) is used as a common power source to apply voltage to all the pulleys. However, multiple (two in this embodiment) high voltage DC power sources 55 may be provided.

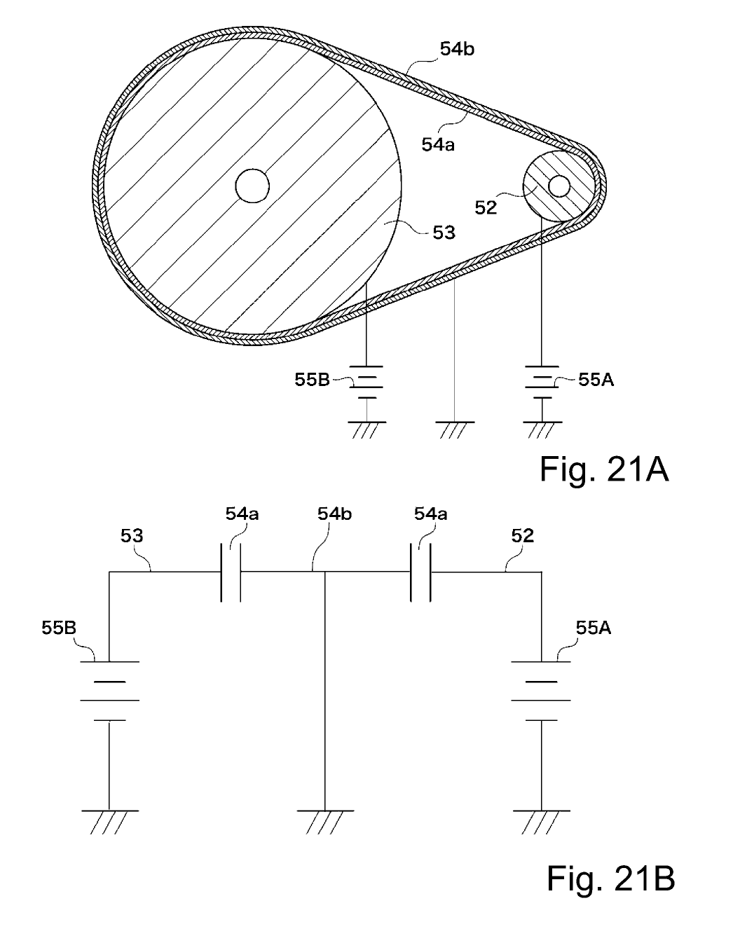

FIG. 21A is a sectional view of the driving force transmitting device 50 in the sixth embodiment. FIG. 21B is an equivalent circuit of the driving force transmitting device 50 shown in FIG. 21A.

To the driving pulley 52, a high voltage DC power source 55A is used to apply voltage, whereas, to the driven pulley 53, a high voltage DC power source 55B is used to apply voltage. The metallic layer 54b of the belt 54 is grounded. The dielectric layer 54a is placed on the inward surface of the belt 54.

By the way, even in the fifth and sixth embodiments, the dielectric layer may be placed on the outward surface of each pulley.

Moreover, the present invention is also applicable to a driving force transmitting device, the driving pulley of which is greater in diameter than its driven pulley, that is, the driven pulley of which rotates faster than its driving pulley. Further, there are cases where the driving pulley and driven pulley are different in coefficient of friction. Thus, in practical terms, the value for the voltage to be applied ought to be set to prevent from slipping, the pulley which is most likely to slip unless the electrostatic adhesive force is present.

Further, regarding the driving force transmitting device 50 in each of the preceding embodiments, the main source of the electrostatic adhesive force for increasing the friction is Coulomb force. However, this does not means that the adhesive force attributable to Johnson-Rahbek force is to be ignored.

By the way, the present invention is compatible with an image forming apparatus having two or more combination of a section to which rotational force is transmitted by a driving force transmitting device, and a driving force source from which driving force is transmitted by a driving force transmitting device. In the case of such an image forming apparatus, the present invention is applicable to each combination. Further, the present invention is applicable regardless of whether the connection between a section to be driven, and a driven pulley, and the connection between a driving force source and a driving pulley, are direct or indirect.

The application of the present invention is not limited to an image forming apparatus such as the above described one. That is, the present invention is also applicable to various other apparatus such as a sheet processing apparatus. Further, even in a case where the present invention is applied to an image forming apparatus, the application does not need to be limited to an image forming apparatus of the electrophotographic type. That is, the present invention is also applicable to image forming apparatuses of other types, for example, the thermal transfer type, ink jet type, etc. In a case where the present invention is applied to an image forming apparatus of the ink jet type, the carriage belt for driving the carriage is the portion to be driven. In a case where the present invention is applied to an image forming apparatus of the thermal transfer type, the platen roller is the portion to be driven.

In the foregoing, the present invention was described in detail with reference to its preferred embodiments. However, these embodiments are not intended to limit the present invention in scope. That is, the present invention includes various driving force transmitting apparatuses (devices) which are in accordance with the gist of the present invention. More over, the present invention includes various driving force transmitting apparatuses (devices) which are combinations of parts or entirety of the driving force transmitting apparatuses (devices) in the preceding embodiments.

According to the present invention, it is possible to reduce a driving force transmitting apparatus (device) in the vibrations and noises which occur as the source of driving force is driven, and also, to highly precisely transmit the rotational force of the driving force source to an object to be driven.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 245133/2013 filed Nov. 27, 2013, which is hereby incorporated by reference.

What is claimed is:

1. A drive transmission device comprising:
a first pulley rotationally driven by a driving unit;
a second pulley;
a belt extended around said first pulley and said second pulley; and
a supply unit for supplying a voltage such that said first pulley and said belt are attracted to each other and that said second pulley and said belt are attracted to each other.

2. A device according to claim 1, wherein said belt is provided with a dielectric layer in the region where said belt contacts said first pulley and said second pulley, and wherein said supply unit electrically grounds said first roller and said second roller and supplies a voltage to said belt.

3. A device according to claim 1, wherein said first pulley is provided with a first dielectric layer in a region where said first pulley is contacted by said belt, and wherein said second pulley is provided with a second dielectric layer in a region where said second pulley is contacted by said belt, and said supply unit grounds said first roller and said second roller and supplies a voltage to said belt.

4. A device according to claim 1, wherein said belt is provided with a dielectric layer in the region where said belt contacts said first pulley and said second pulley, and wherein said supply unit electrically grounds said belt and the supplies of voltage to one of said first roller and said second roller.

5. A device according to claim 1, wherein said first pulley is provided with a first dielectric layer in a region where said first pulley is contacted by said belt, and wherein said second pulley is provided with a second dielectric layer in a region where said second pulley is contacted by said belt, and said supply unit electrically grounds said belt and the supplies of voltage to one of said first roller and said second roller.

6. A device according to claim 1, wherein said belt is provided with a dielectric layer in the region where said belt contacts said first pulley and said second pulley, and wherein said supply unit electrically grounded said belt and supplies voltages to said first roller and to said second roller.

7. A device according to claim 1, wherein said first pulley is provided with a first dielectric layer in a region where said first pulley is contacted by said belt, and wherein said second pulley is provided with a second dielectric layer in a region where said second pulley is contacted by said belt, and said supply unit electrically grounded said belt and supplies voltages to said first roller and to said second roller.

8. A device according to claim 1, wherein an end portion of said belt with respect to a direction perpendicular to a rotational direction of said belt by said driving unit is electrically insulated.

9. An image forming apparatus comprising a drive transmission device according to claim 1, wherein said apparatus comprising an image bearing member connected with said second pulley.

10. An image forming apparatus comprising a drive transmission device according to claim 1, wherein said apparatus further comprising,
a photosensitive member;
an image forming unit for forming an image on said photosensitive member;
a transfer unit for transferring an image formed on said photosensitive member by said image forming unit, onto an intermediary transfer member;
a roller, connected with said second pulley, for rotating said intermediary transfer member.
